(19) United States
(12) Patent Application Publication
(10) Pub. No.: US 2009/0138490 A1
(43) Pub. Date: May 28, 2009

(54) SYSTEM FOR AUTOMATICALLY ANNOTATING INFORMATION

(75) Inventors: Gerrit Hollemans, Eindhoven (NL); Warner Ten Kate, Eindhoven (NL); Vincent P. Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,623

(22) PCT Filed: Nov. 4, 2005
(86) PCT No.: PCT/IB05/53610

§ 371 Date: May 4, 2007

(30) Foreign Application Priority Data
Nov. 10, 2004 (EP) 04105648.2
Oct. 19, 2005 (EP) 05109718.6

(51) Int. Cl. G06F 7/00; G06F 17/00

(52) U.S. Cl. 707/100; 707/E17.045; 707/E17.044

(57) ABSTRACT

Systems (1) such as photo organizer systems for automatically annotating information such as electronic images in dependence of relationship data (111,112) with respect to a first user (101) and a second user (102) and a subject such as another user (103) are provided with first means (11) such as a first table/database for, from points of view of the respective users (101,102), linking the subject such as the other user (103) and respective annotations (42,45) and with second means (12) such as a second table/database for linking the information and the subject such as the other user (103) and with third means (13) such as a user device for annotating the information with the first annotation (42) on behalf of the first user (101) and for annotating the information with the second annotation (45) on behalf of the second user (102). Fourth means (14) such as a third table/database store relationship data with respect to users and provide the first and second annotations (42,45) in dependence of relationship data, to increase the storage efficiency of the system (1).

The invention relates to a system for annotating information, and also relates to a database for use in a system, to a user device for use in a system, to a method for annotating information, to a computer program product for annotating information and to a medium comprising a computer program product.

Examples of such a system are photo organizer systems and examples of such information are electronic images.

A prior art system is known from USApp 20020054059 A1, which discloses an electronic annotation, a retrieval and a use of electronic images. The electronic annotation is done through a drag-and-drop of an annotation from a predefined but extendable list. The annotation is placed at a user selected location on the electronic image and may be a text, an image, a sound etc.

The known system is disadvantageous, inter alia, owing to the fact that the electronic annotation is done through a drag-and-drop of an annotation by hand.

It is an object of the invention, inter alia, to provide a system for annotating information in a relatively automatic way.

Further objects of the invention are, inter alia, to provide a database, a user device, a method, a computer program product and a medium comprising a computer program product for use in (combination with) a system that annotates information in a relatively automatic way.

The system is provided for annotating information with a subject having a subject identifier, comprising

first means for, for a first user, linking the subject identifier and a first annotation, and/or for, for a second user, linking the subject identifier and a second annotation,

second means for linking the information and the subject identifier, and

third means for annotating the information with the first annotation on behalf of the first user and/or for annotating the information with the second annotation on behalf of the second user.

In one example, the information may be a photo showing the first user. An identifier of the first user is linked to the photo. The first means is a database storing a record used for the second user that the first user's identifier corresponds to a text with a name of the first user “Jim”, “school mate” or the like. If the second user likes to see the photo, the photo is annotated beforehand with the text “Jim”, “school mate” or the like.

If the photo was annotated by the first user with a personal annotation like “me”, this personal annotation may be substituted with the text “Jim”, “school mate” or the like. In this manner, one annotation is translated into another annotation in accordance with a preference of the second user as indicated in the database. Of course, instead of the text “me”, the first user could have annotated an item shown on the photo with the text “my item”.

Alternatively, the information is automated automatically for the second user on the basis of the annotation made by the first user and data indicating a relationship between the first and second users. For example, if the first user annotated the photo with the text “me”, and the data indicate that the first user is the brother of the second user, the photo may be automatically displayed to the second user with the text “Brother”.

In one embodiment, the system according to the invention is defined by annotating information in dependence of relationship data with respect to a first user and a second user and a subject, which first and second users are different users, the system comprising

first means for, for the first user, linking the subject and a first annotation and for, for the second user, linking the subject and a second annotation,

second means for linking the information and the subject, and

third means for annotating the information with the first annotation on behalf of the first user and for annotating the information with the second annotation on behalf of the second user.

By providing the system with the first means, from respective points of view of the respective first and second users, the subject is linked to respective first and second annotations, or vice versa. The second means link the information to the subject, or vice versa. The third means annotate the information with the respective first and second annotations on behalf of the respective first and second users. The combination of the first and second and third means, which first and second and third means form part of one device or of two or three separate devices, allows the information to be annotated automatically.

The invention is further advantageous, inter alia, in that the system according to the invention is more user-friendly. The first means may comprise distributed sub-means at distributed locations, such as first sub-means for, from a point of view of the first user, linking the subject and a first annotation and second sub-means for, from a point of view of the second user, linking the subject and a second annotation, or not.

An embodiment of the system according to the invention is defined by the subject being a third user. Especially for a subject in the form of a third user, the first and second and third means will be advantageous. In this case, the information may be annotated in dependence of for example respective first and second relationship data with respect to the respective first and second users on the one hand and the third user on the other hand.

An embodiment of the system according to the invention is defined by the system further comprising

fourth means for storing at least two relationship data of at least three relationship data comprising first relationship data with respect to the first user and the subject, and second relationship data with respect to the second user and the subject and third relationship data with respect to the first user and the second user and for providing the first and second annotations in dependence of at least one relationship data of the stored relationship data.

The fourth means allow the first and second annotations to be derived from the at least one relationship data (or data-piece or data-signal) of the at least two stored relationship data (or data-pieces or data-signals) by supplying the at least one relationship data to the first means, as follows. Of three relationship data present with respect to (or between) three pairs of users and/or subjects, each pair of users and/or subjects comprising two out of the three users and/or subjects, two relationship data need to be known to be able to derive the last one. One or two of the two stored relationship data or one or two or three of the three stored relationship data will allow the subject and the first annotation to be linked from a point of view of the first user and will allow the subject and the second annotation to be linked from a point of view of the second user. The fourth means will increase the storage efficiency of the system according to the invention, owing to the fact that it will be no longer necessary to store each link between each user and/or subject and each annotation from each point of view of each user. The fourth means form part of the same device as one or more of the first and second and third means or form part of another device.

An embodiment of the system according to the invention is defined by the subject being a third user. Especially for a subject in the form of a third user, the fourth means will be advantageous. In this case, the information may be annotated in dependence of for example respective first and second relationship data with respect to the respective first and second users on the one hand and the third user on the other hand.

An embodiment of the system according to the invention is defined by the system comprising a photo organizer system, the information comprising an electronic image photo, the relationship data defining family relationships, and the annotations comprising nomenclatures.

An embodiment of the system according to the invention is defined by the first means forming at least a part of a first database, the second means forming at least a part of a second database and the third means forming at least a part of a user device arranged to communicate with at least a part of the first and second means. The first and second databases may be different databases or may be one and the same database, and each database may form part of the user device or not. The first means and/or the second means may form part of the user device or not.

An embodiment of the system according to the invention is defined by the fourth means forming at least a part of a third database arranged to communicate with at least a part of the first and second means. The first and second and third databases may form part of two or three different databases or may be one and the same database, and each database may form part of the user device or not. The fourth means may form part of the user device or not.

Embodiments of the database according to the invention and of the user device according to the invention and of the method according to the invention and of the computer program product according to the invention and of the medium according to the invention correspond with the embodiments of the system according to the invention. The database according to the invention (the first and/or second and/or fourth means) and the user device according to the invention (the third means) may be produced and/or sold separately from the system according to the invention.

The invention is based upon an insight, inter alia, that dragging-and-dropping is old-fashioned, and is based upon a basic idea, inter alia, that information can be annotated with annotations on behalf of users automatically by linking a subject such as a further user and the annotations from the points of view of the users and by linking the information and the subject such as the further user.

The invention solves the problem, inter alia, to provide a system for annotating information in a relatively automatic way, and is further advantageous, inter alia, in that the system according to the invention is more user-friendly.

These and other aspects of the invention will be apparent from and elucidated with reference to the embodiments(s) described hereinafter.

In the drawings:

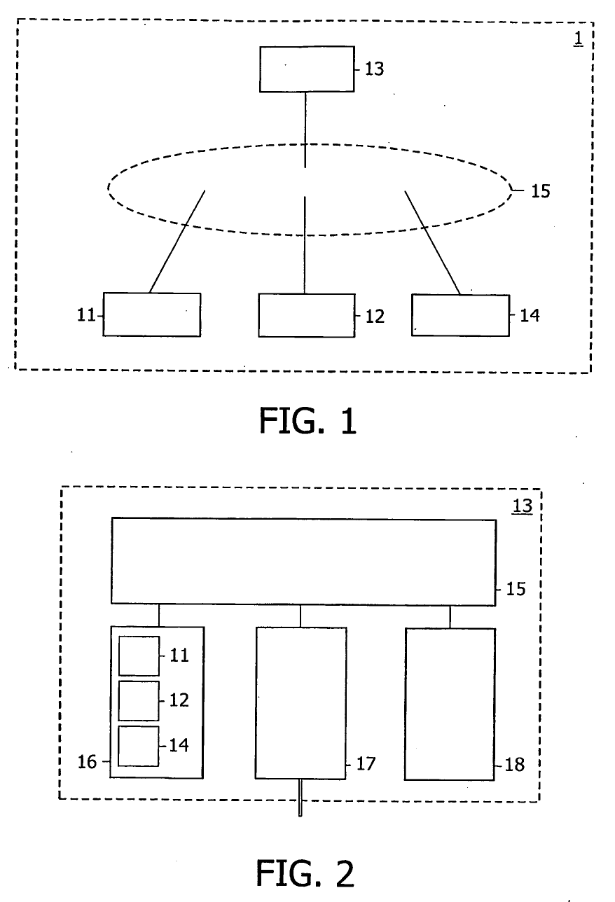

FIG. 1 shows diagrammatically a system according to the invention comprising a database according to the invention and a user device according to the invention,

FIG. 2 shows diagrammatically a user device according to the invention comprising a database according to the invention,

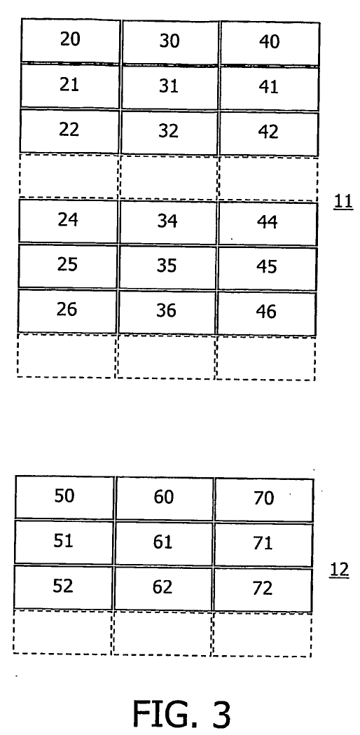

FIG. 3 shows diagrammatically first means forming part of a first database according to the invention and second means forming part of a second database according to the invention, and

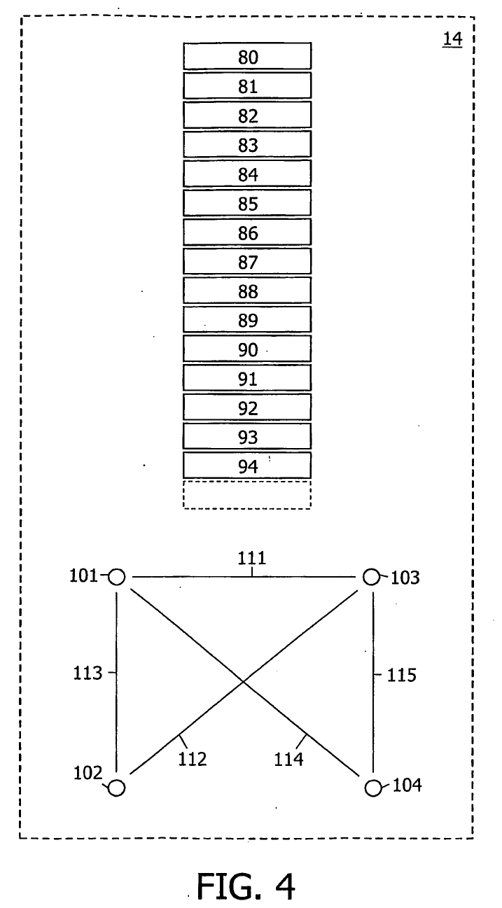

FIG. 4 shows diagrammatically fourth means forming part of a third database according to the invention.

The system 1 according to the invention shown in FIG. 1 comprises first means 11, second means 12, third means 13 and fourth means 14 coupled to and/or connected to each other via for example a network 15 such as for example an internet, without excluding other kinds of couplings and/or connections.

The user device according to the invention shown in FIG. 2 comprises the third means 13 that comprise a processor 15 coupled to and/or connected to a memory 16, to a network interface 17 coupled to and/or connected to for example the network 15, and to a man machine interface 18. The memory 16 comprises for example the first means 11, the second means 12 and the fourth means 14.

The first means 11 form part of a first database according to the invention and the second means 12 form part of a second database according to the invention as shown in FIG. 3 (upper part: first means 11, lower part: second means 12).

The first means 11 for example comprise a first column disclosing user identifiers 20-26, a second column disclosing type indications 30-36 and a third column disclosing annotations 40-46. For example, in a first and general row, 20=user identifier, 30 type indication, 40=annotation. In a second and more particular row, from a point of view of a user A, 21=user B, 31=human, 41=“son”. In a third and more particular row, from the point of view of the user A, 22=user C, 32=human, 42=“honey”. In a fifth and more particular row, from a point of view of a user B, 24=user A, 34=human, 44=“papa”. In a sixth and more particular row, from the point of view of the user B, 25=user C, 35=human, 45=“mama”. So, the second and the third and possibly a fourth row are destined to disclose the point of view of the user A, and the fifth and the sixth and possibly a seventh row are destined to disclose the point of view of the user B etc.

The second means 12 for example comprise a first column disclosing information identifiers 50-52, a second column disclosing type indications 60-62 and a third column disclosing further indications 70-72. For example, in a first and general row, 50=information identifier, 60=type indication, 70=further indication. In a second and more particular row, 51=information E, 61=user A+user B, 71=JPEG. In a third and more particular row, 52=information F, 62=user C, 72=bitmap etc.

The fourth means 14 form part of a third database according to the invention as shown in FIG. 4 (upper part: fourth means 14, lower part: schematic relationships) and for example discloses family ontology, 80=class (human), 81=subclass (male, human), 82=subclass (female, human), 83=disjoint (male, female), 84=relation (married to), 85=inverse (married to, married to), 86=inverse (parent, child), 87=inverse (sibling, sibling), 88=relation (sibling), 89=subrelation (brother, sibling), 90=subrelation (sister, sibling), 91=range (brother, male), 92=range (sister, female), 93=same (uncle, father-brother), 94=same (parent, sibling-parent) etc.

In the schematic relationships, user A=first user 101 (husband, father), user B=second user 102 (son; brother), user C=third user 103 (wife, mother) and user D=fourth user 104 (daughter, sister). Users A and C are husband and wife, user B is a son of the users A and C, and user D is a daughter of the users A and C. Between (or with respect to) the users A and C, there is first relationship data 111 (husband-wife), between (or with respect to) the users B and C, there is second relationship data 112 (son-mother), between (or with respect to) the users A and B, there is third relationship data 113 (father, son), between (or with respect to) the users A and D, there is fourth relationship data 114 (father, daughter), between (or with respect to) the users B and D, there is fifth relationship data 115 (mother, daughter) etc.

Although the upper part and the lower part of FIG. 4 have been described separately, the options given in the upper part are of course to be used in the lower part of FIG. 4, whereby this lower part of FIG. 4 can be converted into a table too.

The system 1 annotates information identified by information identifiers 50-52 in dependence of for example respective first and second relationship data 111,112 with respect to the respective first and second users 101,102 on the one hand and the third user 103 on the other hand, which first and second users 101-102 are different users. This system 1 comprises the first means 11 for, from a point of view of the first user 101, linking the third user 103 and a first annotation 42 (the husband calls his wife “honey”) and for, from a point of view of the second user 102, linking the third user 103 and a second annotation 45 (the son calls his mother “mama”). The system 1 further comprises the second means 12 for linking the information and the third user 103 (the information identified by information identifier 52 shows the wife and mother) and the third means 13 for annotating the information with the first annotation 42 on behalf of the first user 101 (the husband calls his wife “honey”) and for annotating the information with the second annotation 45 on behalf of the second user 102 (the son calls his mother “mama”).

The first and second and third means 11-13 allow information identified by information identifiers 50-52 to be annotated automatically. The first means 11 may comprise distributed sub-means 11a, 11b not shown at distributed locations, such as first sub-means 11a for, from a point of view of the first user 101, linking the third user 103 and a first annotation 42 and second sub-means 11b for, from a point of view of the second user 102, linking the third user 103 and a second annotation 45 etc.

The system 1 may further comprise the fourth means 14 for storing at least two relationship data (or data-pieces or data-signals) of at least three relationship data 111-113 comprising the first relationship data 111 between the first user 101 and the third user 103 and the second relationship data 112 between the second user 102 and the third user 103 and the third relationship data 113 between the first user 101 and the second user 102 and for providing the first and second annotations 42,45 in dependence of at least one relationship data of the stored relationship data.

The fourth means 14 will increase the storage efficiency of the system 1, owing to the fact that it will be no longer necessary to store each link between each user and each annotation from each point of view of each user.

The system 1 for example comprises a photo organizer system, the information for example comprises an electronic image photo, the relationship data for example define family relationships, and the annotations for example comprising nomenclatures, without excluding other options.

The first means 11 may form at least a part of a first database, the second means 12 may form at least a part of a second database and the third means 13 may form at least a part of a user device arranged to communicate with at least a part of the first and second means 11,12. The fourth means 14 may form at least a part of a third database arranged to communicate with at least a part of the first and second means 11,12.

The FIG. 1-4 show embodiments in a non-limited way. So, in FIG. 1, more means and more couplings and/or connections may be present. In FIG. 2, more blocks next to and/or inside the blocks shown may be present. In FIGS. 3 and 4, more rows and/or columns and/or entries may be present, without departing from the scope of this invention.

So, the invention is related to collaborative annotation using ontologies and reasoning. It is known to annotate photos manually. However, each user may annotate a photo using a personal reference (e.g., “my mom”) which other users would not use with respect to the photo. For example, a son may annotate a photo “my mom”, but a husband may annotate the same photo “honey”. In this situation the husband may not benefit from the annotation of the photo by the son.

According to the invention, a user is enabled to use the annotation of another user so that the amount of efforts of the user is reduced for annotating the same photos that have been annotated by the other user. The invention utilizes knowledge about a relationship between the users, e.g., family ontology, to for example interpret a search request from the user for photos. The user may use words like “my sister”, “my brother”, and etc. in the search request. Using the family ontology knowledge, the search request “my sister” is interpreted as “user D”. The family ontology may indicate a relationship between the users, e.g., brother or sister. The family ontology may be recorded in form of a table owned by the user, e.g.: User D (Maud)—sister, User A (Bill)—father (or parent). Reasoning algorithms may be used to infer relations between users.

The invention may also be used for interpreting an annotation when the annotation is presented to a user different from an original user who first made the annotation. For example, if John, brother of Maud, annotated a photo as “my sister”, then, when the photo is presented to Maud, the annotation may be translated for her into “me”. This example may be extended from the text annotations into an audio or video domain. The invention may be used not only for the annotations of photos but, generally for any information which is possible to annotate.

With the advent of digital still cameras consumers are rapidly building digital photo collections that increase on average with about 1000 pictures per year. An interesting paradox arises when the organization of such a collection is considered: Users would like the collection to be organized, but do not want to spend time to organize the collection. Consequently, any support from a system to help organize the collection is welcome. For personal photo collections several attributes might be important to register. Most notably the event depicted in the photo, the location where the photo was taken and who are on the photo. For the latter attribute there may be methods to annotate photos semi-automatically using face recognition technology. However, such technology internally works with mathematical models and faceIDs, requiring users to enter at least once the names to the faces that are recognized.

For photo collections, which typically are owned by multiple family members, a problem arises. The references that people make to other persons are personal in nature and largely determined by the relation between persons. Parents refer to each other using nick names, but children are unlikely to use these references to their parents. Similarly, brothers and sisters of parents are uncles and aunts to the children. These differences in personal references to people means that users are required to enter their own references in the system in relation to the faceIDs. Alternatively, users can split up the work to be done, each doing part of the data entry. However, in that case users need to agree on the references to be used, which will then be unfit for at least some of them.

The situation gets even worse when face recognition is lacking, requiring quite some additional annotations from the user (very likely the case), or not available at all. Then everything has to be done manually and, without additional measures, users can not benefit from the efforts of other users. It would be a great benefit if users do not have to do all the annotations, while still being able to use their own references to persons. A photo annotation method and annotation ontology providing knowledge describing features of the subject-matter of photos is described in a paper by A. Th. Schreiber, B. Dubbeldam, J. Wielemaker, and B. J. Wieling a “Ontology based photo annotation” IEEE Intelligent Systems, 16(3):66-74, May/June 2001. Use of the photo annotation ontology for search engines is also described in the paper.

The invention presents a solution that reduces the amount of effort users need to perform in annotating the photos, while at the same time they can use their own preferred nomenclature in labeling the photos. The reduction arises from using the annotations by other users (while not necessarily having that other user's annotation being displayed).

Two measures might be taken. The first is that with each user of the photo organizer system we associate a separate database (or a table of a database), see FIG. 3. The database stores the individual nomenclatures of that user and relates each of them to a system-defined ID for that type of nomenclature. For example, assume user A (the father, named Bill) calls his wife (user C, named Sarah) “honey”, and she calls him “Bill”. Then, the database for user A lists for the system ID (22) type human (32) the name “honey” (42) and the table for user C lists for the system ID also of type human the name “Bill”. A photos depicting the mother is annotated with the system ID in a further database of a further table of a (further) database, see FIG. 3. The photo ID (52) links to a file-system that holds the actual photo images.

For clarity, where one term, such as “honey” or “Bill” is used, also a list could be used. For example, in the user A table “honey” can be one out of a list of (nick) names. If the father looks for a photo of his wife he would query for “honey”. The user A table translates this query for “honey” into a query to the photo database for system ID (22) of type human (32). The photo database returns the photo ID (52), which subsequently is used to fetch the image. Note, that it is not required that the photos have ever been annotated with “honey”. It suffices that the photos have received the system ID (52) during some annotation. For example, user C could have annotated this photo as “me”.

The information in the tables is entered as follows. The user tables are filled by each user himself. The table can grow incrementally during several sessions. In order the system can identify which user table to use, the ID (20) of the user (user A or user B in the example) is either asked by the system, e.g. through a logon dialog, or by some other means. The system IDs are generated by the system, for example similar to the way UUIDs and GUIDs are generated. Instead of an abstract ID, also concrete names can be used, like Bill and Sarah. A system ID is generated once the need occurs. For example, if the mother annotates a photo depicting herself for the first time, she enters the annotation “me” and informs the system the annotation concerns of type “human”. The system generates the system ID of type human, creates the corresponding row in the user C table, and enters the annotation row in the photo table.

Of course, to be successful, the system ID in the father's table needs to be the same. This can be done by showing the list of humans already present in the system each time a user annotates a photo with a type human (after first screening whether the nomenclature isn't already present). Instead of showing a plain list one could also use the second measure, which concerns the use of ontologies, see FIG. 4.

A schema of family relations is designed, like the ones displayed in the upper part of FIG. 4. The ontology holds knowledge like all concepts are humans; a male can be marriedTo at most one female; marriedTo is the inverse relation of marriedTo; child is the inverse relation of parent; brother and sister are subrelations of the relation sibling, where brother connects to a human of the subclass male; uncle is the brother of a father; etc. These concepts, relations, and restrictions are known to a part of the photo organizer system which is called the reasoner. The reasoner uses this knowledge to infer (family) relations that are not entered explicitly by its users. For example, in FIG. 4, knowing Bill is marriedTo Sarah, and knowing the four parent relations, enables to infer that Sarah is marriedTo Bill, they have the children John and Maud, but also that Maud is the sister of John.

The reasoning is helpful to simplify the list view to the user. For example, if Bill has annotated a photo with “my brother and my son”. Then, his son will see the annotation “me and my uncle”. Next to this ontology, the system may also store some of the family relations that hold for its user set. For example, assume user A has once entered he is marriedTo Sarah. At that moment in time the system ID of type human is generated and entered in the system. Obviously, also for each user an ID is generated and stored. So, the new ID might already have been present. If a user annotates a photo, he enters the new name, which is checked for not yet being in the user's nomenclature. If not, a new row is created in the user's table and the user is asked to relate the name to at least one instance (person) in the ontology of FIG. 4. At least one relation from the upper part must be used and attached to a person in the graph in the lower part. The user may use any relation and connect to any person. The reasoning process ensures that all other relations to all other persons are inferred. Hence, the reasoner can decide whether the new person is new indeed or already existent in the tables (and reassign the ID value).

In some situations the reasoner cannot be completely decisive. For example, if Jon is added as child of Bill, it can not be decided whether Jon is another name for John or Maud, or is a new born. So, the system needs to ask the user whether Jon is one of {John, Maud} or a new person to add. This is still a reduction compared to showing the whole list. Also, when later Sarah would query for photos of her children, all IDs are known (can be inferred). Additional knowledge, like the system knowing that Bill and Sarah have 2 children, can refine this principle.

The same approach of interaction can be used upon retrieving photos. Instead of showing the full list of system IDs, the family relations are shown (or shown in addition), and the user is offered to navigate these relations in creating his query. The photos related to the current node in the graph might be shown while traversing the graph. Also, for the persons for whom the current user doesn't has a nomenclature, the family relation can be displayed instead. Another extension is that one user can use another user's nomenclature by directing to that other's user's nomenclature. For example, the son can query for “dad's honey”.

A method of processing information might comprise the steps of obtaining ontology data indicating a particular relationship type between a first user and a second user, obtaining information (e.g., a search query input by the first user or a photo annotation made by the second user), and analyzing the ontology data to interpret the information. The information might be a search query input by the first user, the search comprising an indication (e.g., “friend” or “sister” or “former colleague”) related to the second user or a third person (e.g., “girlfriends father”) whose relationship type with the second user is also defined in the ontology data, and the method might further comprise a step of processing the user query to replace the indication by (or to include into the indication) an identifier of the second user or the third person extracted using the ontology data. The information might be a media content (e.g., a photo) item comprising an indication (e.g., photo annotation) expressing a relationship type between the second user and the first or third user, and the method might further comprise a step of processing the indication so that it expresses a relationship type between the between the first user and the second user or the third user.

In view of the above, instead of annotating information in dependence of for example respective first and second relationship data 111,112 with respect to the respective first and second users 101,102 on the one hand and the third user 103 on the other hand, information may be annotated in dependence of first and second relationship data with respect to a first user and a second user and a subject. For example, a picture with a boat may be annotated on behalf of the father with “my boat”, on behalf of the mother by “Bill's boat” and on behalf of a kid by “dad's boat”. In that case, the first means 11 will, for the first user, link the subject and a first annotation and will, for the second user, link the subject and a second annotation. The second means 12 will then link the information and the subject, and the third means 13 will then annotate the information with the first annotation on behalf of the first user and will annotate the information with the second annotation on behalf of the second user.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. System (1) for annotating information with a subject having a subject identifier, comprising
first means for, for a first user (101), linking the subject identifier and a first annotation (42), and/or for, for a second user (102), linking the subject identifier and a second annotation (45),
second means (12) for linking the information and the subject identifier, and
third means (13) for annotating the information with the first annotation (42) on behalf of the first user (101) and/or for annotating the information with the second annotation (45) on behalf of the second user (102).

2. The system of claim 1, wherein the subject is the first user, the second user, or a personal object of the first user or the second user.

3. The system of claim 1, wherein the third means are configured for annotating the information in dependence of relationship data (111,112) with respect to the first user (101), the second user (102) and the subject, which first and second users (101-102) are different users.

4. System (1) according to claim 3, the system (1) further comprising
fourth means (14) for storing at least two relationship data of at least three relationship data (111-113) comprising first relationship data (111) with respect to the first user (101) and the subject and second relationship data (112) with respect to the second user (102) and the subject and third relationship data (113) with respect to the first user (101) and the second user (102) and for providing the first and second annotations (42,45) in dependence of at least one relationship data of the stored relationship data.

5. System (1) according to claim 3, wherein the subject is a third user (103).

6. System (1) according to claim 3, the system (1) comprising a photo organizer system, the information comprising an electronic image photo, the relationship data (111-115) defining family relationships, and the annotations (40-46) comprising nomenclatures.

7. System (1) according to claim 1, the first means (11) forming at least a part of a first database, the second means (12) forming at least a part of a second database and the third means (13) forming at least a part of a user device arranged to communicate with at least a part of the first and second means (11,12).

8. System (1) according to claim 4, the fourth means (14) forming at least a part of a third database arranged to communicate with at least a part of the first and second means (11,12).

9. Database for use in a system (1) as defined in claim 7.

10. User device for use in a system (1) as defined in claim 7.

11. Method for annotating information related to a subject having a subject identifier, the method comprising the steps of
for a first user (101), linking the subject identifier and a first annotation (42) and/or, for a second user (102), linking the subject identifier and a second annotation (45),
linking the information and the subject identifier, and
annotating the information with the first annotation (42) on behalf of the first user (101) and/or annotating the information with the second annotation (45) on behalf of the second user (102).

12. The method of claim 11, wherein the information is annotated in dependence of relationship data (111,112) with respect to a first user (101) and a second user (102) and a subject, which first and second users (101-102) are different users.

13. A computer program product including code means adapted to implement, when executed on a computing device, the steps of the method as claimed in claim 11.

14. Medium comprising the computer program product as defined in claim 13.
